(19) United States
(12) Patent Application Publication
(10) Pub. No.: US 2020/0241450 A1
(43) Pub. Date: Jul. 30, 2020

(54) BELT DEVICE, TRANSFER DEVICE, AND IMAGE FORMING APPARATUS

(71) Applicant: Yoshiki HOZUMI, Kanagawa (JP)

(72) Inventor: Yoshiki HOZUMI, Kanagawa (JP)

(73) Assignee: Ricoh Company, Ltd., Tokyo (JP)

(21) Appl. No.: 16/740,610

(22) Filed: Jan. 13, 2020

(30) Foreign Application Priority Data
Jan. 25, 2019 (JP) 2019-011345
Nov. 22, 2019 (JP) 2019-211564

(51) Int. Cl. G03G 15/16

(52) U.S. Cl. CPC G03G 15/1615

(57) ABSTRACT

A belt device includes an endless belt, a plurality of support rollers mounted on rotary shafts to stretch and support the endless belt, and a shaft displacement unit to displace a rotary shaft of one of the plurality of support rollers. The shaft displacement unit includes a belt contact rotator that is rotatable, a belt detector rotatable on the rotary shaft and movable when the belt contact rotator pushes the belt detector, a shaft inclination member not rotatable on the rotary shaft and movable when the belt detector pushes the shaft inclination member. The belt contact rotator contacts an edge of the endless belt and moves in a longitudinal axial direction of the one of the plurality of support rollers when the endless belt moves in the longitudinal axial direction. The shaft inclination member has an inclined face inclined with respect to the endless belt.

### CROSS-REFERENCE TO RELATED APPLICATIONS

This patent application is based on and claims priority pursuant to 35 U.S.C. § 119(a) to Japanese Patent Application Nos. 2019-011345, filed on Jan. 25, 2019 and 2019-211564, filed on Nov. 22, 2019, in the Japan Patent Office, the entire disclosure of each of which is hereby incorporated by reference herein.

### BACKGROUND

### Technical Field

Embodiments of the present disclosure generally relate to a belt device, a transfer device, and an image forming apparatus.

### Description of the Related Art

Certain belt devices include a plurality of support rollers to stretch and support an endless belt and a shaft displacement unit to displace a rotary shaft of one of the plurality of the support rollers.

### SUMMARY

Embodiments of the present disclosure describe an improved belt device that includes an endless belt, a plurality of support rollers mounted on rotary shafts and configured to stretch and support the endless belt, and a shaft displacement unit configured to displace the rotary shaft of one of the plurality of support rollers. The shaft displacement unit includes a belt contact rotator that is rotatable, a belt detector that is rotatable on the rotary shaft and movable relative to the rotary shaft when the belt contact rotator pushes the belt detector, and a shaft inclination member that is not rotatable on the rotary shaft and is movable relative to the rotary shaft when the belt detector pushes the shaft inclination member. The belt contact rotator is configured to contact an edge of the endless belt and move in a longitudinal axial direction of the one of the plurality of support rollers when the endless belt moves in the longitudinal axial direction. The shaft inclination member has an inclined face inclined with respect to the endless belt.

### BRIEF DESCRIPTION OF THE SEVERAL VIEWS OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is a schematic view illustrating a configuration of an image forming apparatus according to an embodiment of the present disclosure;

FIG. 2 is a schematic view illustrating a configuration of a shaft displacement unit of an intermediate transfer belt device included in the image forming apparatus in FIG. 1 immediately after assembly;

FIG. 3 is a schematic view illustrating a configuration of the shaft displacement unit when belt crawl occurs;

FIG. 4 is a cross-sectional view along line A-A in FIG. 2;

FIG. 5 is a cross-sectional view along line A-A in FIG. 3;

FIG. 6A is a perspective view of a shaft inclination member of the shaft displacement unit;

FIG. 6B is a schematic view of the shaft inclination member as viewed in a longitudinal axial direction;

FIG. 7 is a schematic view illustrating belt crawl of an intermediate transfer belt of the intermediate transfer belt device;

FIG. 8A is a cross-sectional view of a belt detector of the shaft displacement unit;

FIG. 8B is a front view of a belt contact rotator of the shaft displacement unit;

FIG. 9A is a front view of a belt contact rotator according to a variation of the present disclosure;

FIG. 9B is a side view of the belt contact rotator according to the variation of the present disclosure; and

FIG. 9C is a rear view of the belt contact rotator according to the variation of the present disclosure.

The accompanying drawings are intended to depict embodiments of the present disclosure and should not be interpreted to limit the scope thereof. The accompanying drawings are not to be considered as drawn to scale unless explicitly noted. In addition, identical or similar reference numerals designate identical or similar components throughout the several views.

### DETAILED DESCRIPTION

Descriptions are given of embodiments of the present disclosure with reference to the drawings.

In describing embodiments illustrated in the drawings, specific terminology is employed for the sake of clarity. However, the disclosure of this patent specification is not intended to be limited to the specific terminology so selected, and it is to be understood that each specific element includes all technical equivalents that have the same function, operate in a similar manner, and achieve a similar result.

As used herein, the singular forms “a”, “an”, and “the” are intended to include the plural forms as well, unless the context clearly indicates otherwise.

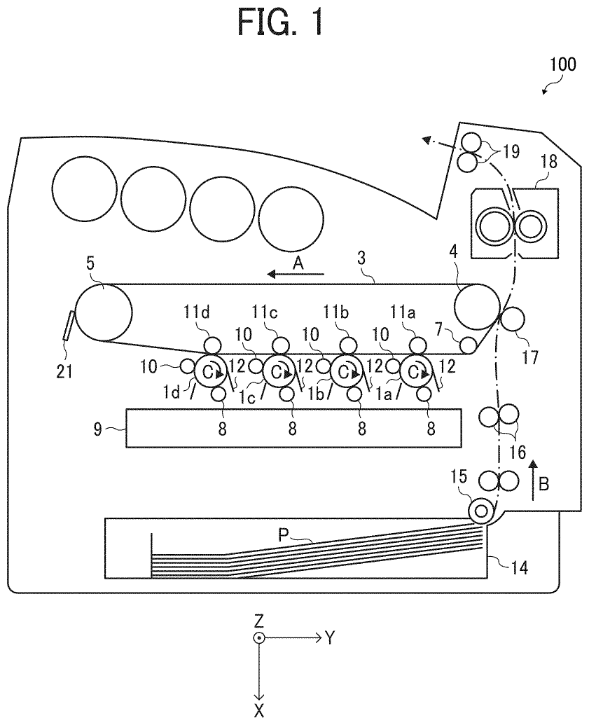

FIG. 1 is a schematic view illustrating a configuration of an example of an image forming apparatus 100, which is a printer in the present embodiment. The image forming apparatus 100 illustrated in FIG. 1 includes a plurality of photoconductors disposed in a housing of the image forming apparatus 100 (i.e., first to fourth photoconductors 1a, 1b, 1c, and 1d). In the example in FIG. 1, toner images of different colors (i.e., black, magenta, cyan, and yellow toner images) are formed on the photoconductors 1a, 1b, 1c, and 1d, respectively.

As illustrated in FIG. 1, the photoconductors 1a, 1b, 1c, and 1d are drum-shaped. Alternatively, an image forming apparatus can employ, as photoconductors, endless belts entrained around a plurality of rollers and driven to rotate.

An intermediate transfer belt 3 as an intermediate transferor is opposed to the first to fourth photoconductors 1a, 1b, 1c, and 1d, and each of the photoconductors 1a, 1b, 1c, and 1d contacts a surface of the intermediate transfer belt 3. The intermediate transfer belt 3 is wound around a plurality of support rollers, that is, a drive roller 4, a tension roller 5, and an entry roller 7. As a drive source drives the drive roller 4, which is one of the plurality of support rollers, the intermediate transfer belt 3 rotates in the direction indicated by arrow A in FIG. 1.

The intermediate transfer belt 3 is either a multi-layer belt or a single-layer belt. In the case of the multi-layer belt, the intermediate transfer belt 3 preferably includes a base layer formed of a material, such as fluoroplastic, polyvinylidene fluoride (PVDF) sheet, or polyimide resin, that is less stretchy, and a smooth coat layer formed of, for example, fluoroplastic covers the surface of the intermediate transfer belt 3. In the case of the single-layer belt, the intermediate transfer belt 3 is preferably made of, for example, PVDF, polycarbonate (PC), polyimide (PI), or the like.

Regardless of the color of toner, the configuration and operation to form toner images on the photoconductors 1a, 1b, 1c, and 1d are similar. Similarly, the configuration and operation to transfer the toner images from the photoconductors 1a, 1b, 1c, and 1d onto the intermediate transfer belt 3 are similar, differing only in the color of toner employed. Accordingly, only a description is given of the configuration and operation to form black toner images on the first photoconductor 1a and transfer black toner images onto the intermediate transfer belt 3, as representative.

The photoconductor 1a for black rotates clockwise indicated by arrow C in FIG. 1.

As a discharger irradiates a surface of the photoconductor 1a with light, a surface potential of the photoconductor 1a is initialized. A charging device 8 uniformly charges the initialized surface of the photoconductor 1a to a predetermined polarity (in the present embodiment, a negative polarity). Subsequently, an exposure device 9 irradiates the charged surface of the photoconductor 1a with a modulated laser beam, thereby forming an electrostatic latent image corresponding to writing data on the surface of the photoconductor 1a.

In the image forming apparatus 100 in FIG. 1, the exposure device 9 is a laser writing device that emits the laser beam. Alternatively, the exposure device can include a light-emitting diode (LED) array and an imaging unit.

When the electrostatic latent image on the photoconductor 1a passes a developing device 10, the electrostatic latent image is developed with black toner into a visible image. Primary transfer rollers 11a, 11b, 11c, and 11d are disposed inside a loop of the intermediate transfer belt 3 and opposite the photoconductors 1a, 1b, 1c, and 1d, respectively, via the intermediate transfer belt 3. The primary transfer roller 11a contacts an inner surface of the intermediate transfer belt 3 to form a primary transfer nip between the photoconductor 1a and the intermediate transfer belt 3.

A primary transfer voltage opposite to charging polarity of the toner image on the photoconductor 1a is applied to the primary transfer roller 11a. In the present embodiment, the primary transfer voltage has a plus (positive) polarity. Thus, a transfer electric field is generated between the photoconductor 1a and the intermediate transfer belt 3, and the toner image on the photoconductor 1a is electrostatically transferred onto the intermediate transfer belt 3 that rotates in synchronization with the photoconductor 1a. After the toner image is transferred onto the intermediate transfer belt 3, a cleaning device 12 removes any residual toner adhering to the surface of the photoconductor 1a and clean the surface of the photoconductor 1a.

Similarly, a magenta toner image, a cyan toner image, and a yellow toner image are respectively formed on the second to fourth photoconductors 1b, 1c, and 1d. The toner images of respective colors are sequentially transferred to and superimposed on the intermediate transfer belt 3 in order of yellow, cyan, magenta, and black, thereby forming a composite toner image.

The image forming apparatus 100 has two modes: a full-color mode using at least two of four toners of different colors and a monochrome mode using only black toner. In the full-color mode, the intermediate transfer belt 3 contacts the four photoconductors 1a, 1b, 1c, and 1d, and four color toner images are transferred onto the intermediate transfer belt 3 one on another. By contrast, in the monochrome mode, the intermediate transfer belt 3 contacts only the photoconductor 1a for black, and only the black toner image is transferred onto the intermediate transfer belt 3. In the monochrome mode, the primary transfer rollers 11b, 11c, and 11d are moved away from the photoconductors 1b, 1c, and 1d by a contact-separation mechanism. Accordingly, the intermediate transfer belt is separated from the photoconductors 1b, 1c, and 1d for magenta, cyan, and yellow.

As illustrated in FIG. 1, a sheet feeder 14 is disposed at the bottom of the image forming apparatus 100, and a sheet feeding roller 15 rotates to feed a recording medium P (e.g., transfer sheet) in the direction indicated by arrow B in FIG. 1. Then, a registration roller pair 16 forwards the recording medium P at a predetermined timing to a secondary transfer nip, at which a portion of the intermediate transfer belt 3 looped around the drive roller (support roller) 4 contacts a secondary transfer roller 17 as an example of a transfer device. At that time, the secondary transfer roller 17 is supplied with a predetermined transfer voltage to secondarily transfer the composite toner image from the intermediate transfer belt 3 onto the recording medium P.

The recording medium P carrying the composite toner image is transported upward and passes through the fixing device 18. At that time, the fixing device 18 fixes the composite toner image on the recording medium P with heat and pressure. After the recording medium P passes through the fixing device 18, the recording medium P is ejected outside the image forming apparatus 100 through an output roller pair 19 of a sheet ejection section. A cleaning blade 21 removes any transfer-residual toner adhering to the intermediate transfer belt 3 after the composite toner image is secondarily transferred to the recording medium P. The removed transfer-residual toner is conveyed to an excess toner receptacle.

Next, descriptions are given below of a belt regulator of an intermediate transfer belt device (unit) including the intermediate transfer belt 3. The intermediate transfer belt device serves as a belt device and a transfer device.

In certain image forming apparatuses, various endless belts are used such as a latent image bearer, an intermediate transferor, a conveyor of the recording medium, a fixing member, and the like. Such an endless belt is stretched and looped around at least two support rollers and rotates in a predetermined direction. The endless belt moves (deviates) laterally in a direction perpendicular to the direction of rotation of the belt (i.e., belt crawl occurs) due to its material construction, tolerances of relevant components, or deterioration. Belt crawl causes deviation or misalignment of transferred images on recording media or damage to the belt by coming off the support roller, and must be minimized or corrected.

There is a method for minimizing or correcting belt crawl as follows. A detector detects lateral movement of the belt, and a roller displacement member displaces the support roller around which the belt is stretched taut based on the detected results. Thus, belt crawl can be corrected. In this method, the belt regulator includes a correction roller, a rotator, and a stationary guide. At least one end of the correction roller is movably supported in the direction perpendicular to the belt to correct belt crawl. The rotator is movable on the at least one end of the correction roller along a longitudinal axial direction of the correction roller. The rotator has a contact face that contacts an edge of the belt and an inclined face whose outer diameter changes along the longitudinal axial direction of the belt correction roller. The stationary guide is provided to contact the inclined face of the rotator. In this belt regulator, as the edge of the belt that moves laterally contacts the rotator, the rotator moves due to movement of the belt, thereby inclining the correction roller to correct belt crawl.

In other words, the belt regulator according to the present embodiment employs a shaft inclination method to incline an axis of rotation of the tension roller 5, which is one of the plurality of support rotators that stretches the intermediate transfer belt 3, to align the intermediate transfer belt 3 within a predetermined range.

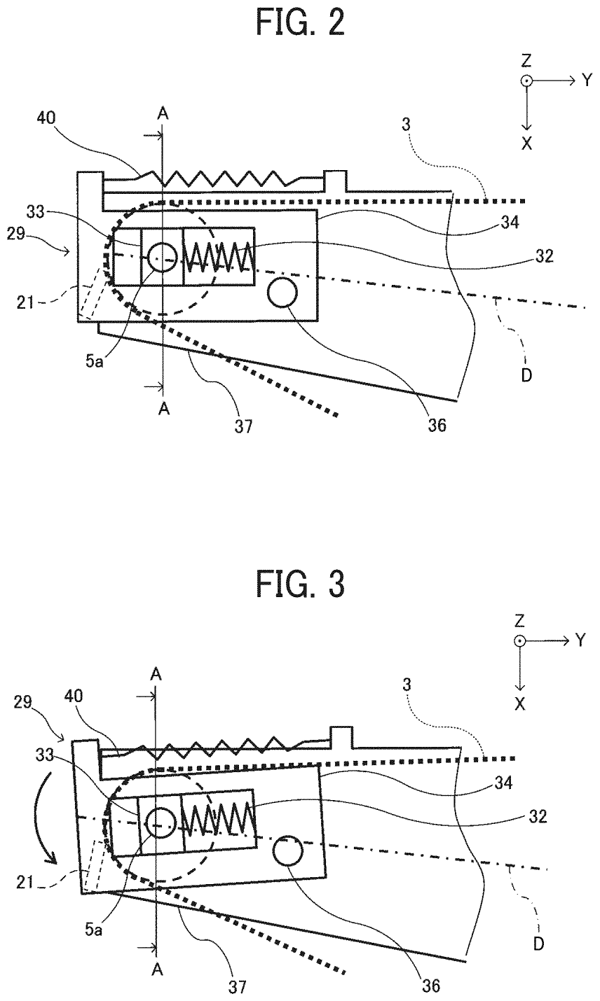

FIG. 2 is a schematic view illustrating a shaft displacement unit serving as the belt regulator of the intermediate transfer belt device immediately after assembly, as viewed from the front side in the longitudinal axial direction of the tension roller 5 in FIG. 1. FIG. 3 is a schematic view illustrating the shaft displacement unit of the intermediate transfer belt device when belt crawl occurs, as viewed from the front side in the longitudinal axial direction of the tension roller 5 in FIG. 1.

The tension roller 5 is mounted on a rotary shaft 5a. Both ends of the rotary shaft 5a of the tension roller 5 according to the present embodiment are supported by swingable support units 29 that displace the rotary shaft 5a of the tension roller 5 to incline the tension roller 5. Alternatively, a swingable support unit 29 can be provided only at one end instead of both ends of the rotary shaft 5a. The swingable support unit 29 includes a tension roller bearing 33 that applies tension to the intermediate transfer belt 3 while supporting the tension roller 5, a tension spring 32 that applies the tension to the tension roller bearing 33, and a swingable support 34 that is swingably supported around a spindle 36 on a frame 37 of the intermediate transfer belt device. Further, a support spring 40 urges the swingable support 34 to rotate around the spindle 36 clockwise in FIG. 2.

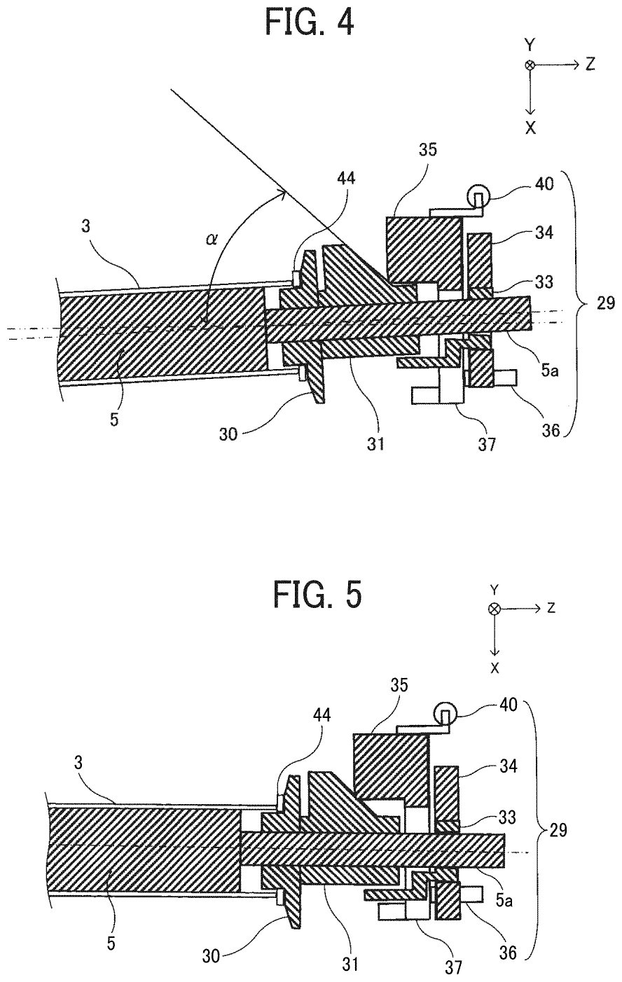

FIG. 4 is a cross-sectional view along line A-A in FIG. 2. FIG. 5 is a cross-sectional view along line A-A in FIG. 3. The belt regulator employs the following configuration to incline the tension roller 5 using the force of belt crawl of the intermediate transfer belt 3. A belt detector 30 and the shaft inclination member 31 are disposed on the rotary shaft 5a of the tension roller 5 and movable in the longitudinal axial direction of the tension roller 5. The belt detector 30 contacts an end face of the tension roller 5. The shaft inclination member 31 is disposed outboard of the belt detector 30. The rotary shaft 5a has a diameter smaller than that of a roller portion of the tension roller 5.

A shaft guide 35 is disposed on the frame 37. As the shaft inclination member 31 contacts the shaft guide 35, the swingable support 34 keeps the rotational position against biasing force of the support spring 40. In FIGS. 4 and 5, a belt contact rotator 44 according to the present embodiment is interposed between the edge of the intermediate transfer belt 3 and the belt detector 30. These components are described in detail later. In FIG. 4, the two-dot chain line indicates the Y-Z plane, and the one-dot chain line indicates the center line of the tension roller 5. The tension roller 5 is inclined with the right side in FIG. 4 positioned higher than the left side immediately after the assembly as illustrated in FIG. 4. With this configuration, the intermediate transfer belt 3 initially moves toward the right in FIG. 4 (i.e., belt crawl occurs), and then belt crawl is corrected in a state in which the intermediate transfer belt 3 deviates to the right as illustrated in FIG. 5.

As illustrated in FIGS. 2 and 3, the spindle 36 that supports the swingable support 34 is disposed at the position opposite to the contact position where the shaft inclination member 31 contacts the shaft guide 35, with respect to the bisector D of the angle formed by the intermediate transfer belt 3. Thus, force acts so that the shaft inclination member 31 moves toward the shaft guide 35, and the shaft inclination member 31 can contact the shaft guide 35. If the spindle 36 is disposed so that the shaft inclination member 31 constantly contacts the shaft guide 35, the support spring 40 can be omitted from the viewpoint of securing good contact between the shaft inclination member 31 and the shaft guide 35.

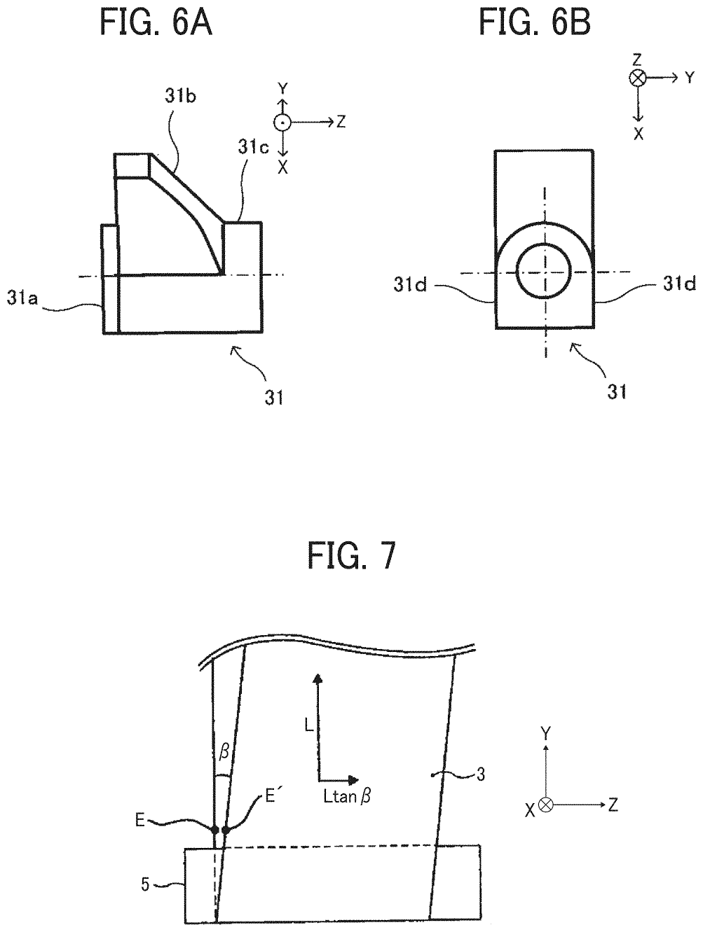

FIG. 6A is a perspective view of the shaft inclination member 31, and FIG. 6B is a schematic view of the shaft inclination member 31 as viewed in the longitudinal axial direction. The shaft inclination member 31 has a contact portion 31a, an inclined portion (inclined face) 31b, and a stopper portion 31c. The contact portion 31a has a cylindrical shape, the inclined portion 31b has a conical curved face, and the stopper portion 31c has a substantially cylindrical shape. The inclined portion 31b has a conical curved face for two reasons: to prevent the position of the tension roller 5 from changing even when the shaft inclination member 31 slightly rotates, and to make point contact between the shaft inclination member 31 and the shaft guide 35.

The point contact between the shaft inclination member 31 and the shaft guide 35 reduces frictional force between the inclined portion 31b of the shaft inclination member 31 and the shaft guide 35. Therefore, the shaft inclination member 31 and the belt detector 30 can move smoothly, thereby reducing force acting between the intermediate transfer belt 3 and the belt detector 30. For this reason, the service life of the intermediate transfer belt 3 is extended. In the present embodiment, for example, the angle at of the inclined portion 31b to the Y-Z plane is 30 degrees (see FIG. 4), and the shaft inclination member 31 is made of polyoxymethylene (POM). The shaft inclination member 31 has flat rotation stoppers 31d on both sides thereof. The flat rotation stoppers 31d contact, for example, stop portions that are integral parts of the tension roller bearing 33, thereby preventing the shaft inclination member 31, which is rotatable on the rotary shaft 5a of the tension roller 5, from rotating.

The shaft guide 35 has a corner portion that is rounded (curved), in particular, into round chamfering. Since the shaft guide 35 has the corner portion, even if a circumference of the intermediate transfer belt 3 changes and the tension roller 5 moves in the direction of rotation of the intermediate transfer belt 3 due to environmental changes, the shaft inclination member 31 can keep point contact with the shaft guide 35 at the same height.

A description is given below of the operation of the belt regulator.

In FIG. 4, as the drive roller 4 starts rotating, the tension roller 5 as a driven roller, around which the intermediate transfer belt 3 is looped, starts rotating. Simultaneously, the belt contact rotator 44 that contacts the edge of the intermediate transfer belt 3 and the belt detector 30 start rotating as well.

In this state, if the intermediate transfer belt 3 moves to the right in FIG. 4 due to effects of parallelism between the components (i.e., belt crawl occurs), the belt contact rotator 44 and the belt detector 30 also move in the same direction in synchronization with belt crawl of the intermediate transfer belt 3. Since the shaft inclination member 31 also contacts the belt detector 30 at the contact portion 31a (see FIG. 6A), the shaft inclination member 31 moves in the same direction.

At that time, since the inclined portion 31b of the shaft inclination member 31 contacts the shaft guide 35, the rotary shaft 5a on the right side in FIG. 4 of the tension roller 5 is displaced downward in FIG. 4 with the rotary shaft 5a on the left side of the tension roller 5 as a fulcrum, thereby inclining the tension roller 5 as illustrated in FIG. 5. Because of the inclination of the tension roller 5, the intermediate transfer belt 3 moves toward the left in FIG. 5, and belt crawl can be reduced and converged. On the other hand, even when the intermediate transfer belt 3 moves in the opposite direction, each component of the belt regulator moves in the reverse direction opposite to the above-described direction from the state in FIG. 5 to the state in FIG. 4, thereby converging belt crawl.

The principle of belt crawl described above caused by inclining the axis of the tension roller 5 is as follows. On the assumption that the intermediate transfer belt 3 is a rigid body, an arbitrary point E on the intermediate transfer belt 3 upstream in the direction of rotation of the intermediate transfer belt 3 from the region winding around the tension roller 5 is observed. In the case in which the plurality of rollers around which the intermediate transfer belt 3 is looped is fully horizontal or parallel, as the tension roller 5 rotates, the arbitrary point E on the intermediate transfer belt 3 does not move in the longitudinal axial direction of the tension roller 5 but rotates around the tension roller 5. Accordingly, belt crawl does not occur.

FIG. 7 is a schematic view illustrating belt crawl of the intermediate transfer belt 3. When the axis of the tension roller 5 is inclined with respect to the axis of the other rollers (e.g., the drive roller 4 and the entry roller 7), as the tension roller 5 rotates by a distance L with an angle of inclination β, the arbitrary point E on the intermediate transfer belt 3 moves in the longitudinal axial direction of the tension roller 5 by L tan β as illustrated in FIG. 7 (i.e., an arbitrary point E′). In FIG. 5, as the rotary shaft 5a is further lowered and the tension roller 5 is inclined down by the angle of inclination β relative to the drive roller 4 disposed upstream in the direction in which the intermediate transfer belt 3 advances to the tension roller 5, the intermediate transfer belt 3 moves toward the left in FIG. 5 by a distance corresponding to tan β while the tension roller 5 rotates.

Since this movement of the intermediate transfer belt 3 is a physical action, as the rotary shaft 5a is lifted above the horizontal plane and the tension roller 5 is inclined upward as illustrated in FIG. 4, the intermediate transfer belt 3 moves to the right in FIG. 4 along with rotation of the tension roller 5.

An amount of belt crawl (i.e., a distance in which the intermediate transfer belt 3 moves in the longitudinal axial direction) is proportional to the angle of inclination β. That is, the amount of belt crawl of the intermediate transfer belt 3 increases as the angle of inclination β increases, and the amount of belt crawl decreases as the angle of inclination β decreases. Therefore, for example, as the intermediate transfer belt 3 moves to the right in FIGS. 4 and 5, the shaft inclination member 31 also moves to the right to lower the rotary shaft 5a on the right side of the tension roller 5. As a result, the tension roller 5 is inclined by an angle proportional to the amount of belt crawl. Thus, belt crawl can be corrected (converged) and the intermediate transfer belt 3 is aligned at the position where belt crawl of the intermediate transfer belt 3 (to the right) is balanced with the correction of belt crawl in the opposite direction (to the left) exerted by inclining the tension roller 5.

At this balanced position, if the intermediate transfer belt 3 further moves to the left or to the right, the shaft inclination member 31 is displaced in proportion to the amount of belt crawl. As a result, the inclination of the tension roller 5 changes, and then belt crawl of the intermediate transfer belt 3 can be corrected (converged) again. That is, belt crawl of the intermediate transfer belt 3 causes the tension roller 5 to be inclined with the angle of inclination corresponding to the amount of belt crawl, thereby correcting (converging) belt crawl of the intermediate transfer belt 3. As described above, according to the present embodiment, belt crawl can be reliably minimized with a simple, low cost configuration.

The belt contact rotator 44 according to the present embodiment is described below.

In the comparative configuration without the belt contact rotator 44, the belt detector 30 directly contacts the edge of the intermediate transfer belt 3 and is pushed by the intermediate transfer belt 3. Accordingly, the edge of the intermediate transfer belt 3 constantly receives stress. The edge is weakest portion of the intermediate transfer belt 3. As a result, buckling of the edge of the intermediate transfer belt 3 may be observed occasionally. If the edge of the intermediate transfer belt 3 slidingly contacts a component, such as the belt detector 30 in the comparative configuration, with a speed difference, each of the edge of the intermediate transfer belt 3 and the component may damage and grind the contacting opponent thereof. Since the belt detector 30 contacts the shaft inclination member 31 that does not rotate, the shaft inclination member 31 brakes rotation of the belt detector 30, causing the speed difference between the intermediate transfer belt 3 and the belt detector 30. When the belt detector 30 is ground, grinding dust may adhere to the surrounding components (e.g., the intermediate transfer belt 3 or the tension roller 5), thereby scratching the surface of the surrounding components.

In the present embodiment, the belt regulator can correct belt crawl without being ground by the intermediate transfer belt 3, thereby providing a long-lasting belt device in which grinding dust does not adhere to the surrounding components. As a result, a low-cost, compact belt device and an image forming apparatus including the belt device can be provided. Specifically, to reduce a speed difference between the intermediate transfer belt 3 and a component that directly contacts the intermediate transfer belt 3, a belt contact rotator 44 is disposed between the intermediate transfer belt 3 and the belt detector 30. The belt contact rotator 44 directly contacts the edge of the intermediate transfer belt 3 and is rotatable relative to the belt detector 30. The belt contact rotator 44 is not secured to the belt detector 30 but is rotatably attached to the belt detector 30. The belt contact rotator 44 contacts the edge of the intermediate transfer belt 3 and is rotated following the rotation of the intermediate transfer belt 3 by the frictional force from the edge of the intermediate transfer belt 3. In addition, the frictional force between the belt detector 30 and the belt contact rotator 44 generates a rotational force to rotate the belt detector 30 following the rotation of the belt contact rotator 44. Since the belt detector 30 contacts the shaft inclination member 31 that does not rotate, the shaft inclination member 31 brakes rotation of the belt detector 30. As a result, the belt contact rotator 44 rotates with a speed difference relative to the belt detector 30.

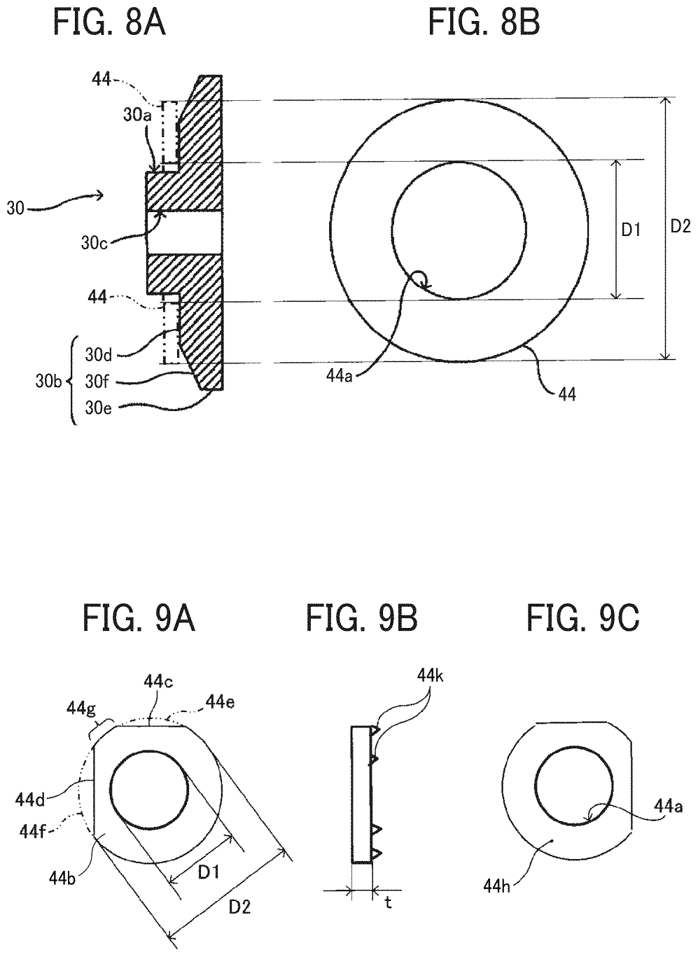

Specifically, as illustrated in a cross-sectional view of FIG. 8A, the belt detector 30 includes a small diameter shaft 30a having a diameter slightly smaller than the diameter of the roller portion of the tension roller 5 and a large diameter flange 30b, and has a through hole 30c. The large diameter flange 30b includes a circular end face 30d and a tapered face 30f. The end face 30d is perpendicular to the circumference of the small diameter shaft 30a. The tapered face 30f connects the outer peripheral edge of the end face 30d and a maximum diameter portion 30e of the large diameter flange 30b. The belt contact rotator 44 is also depicted by imaginary line (two-dot chain line) in FIG. 8A.

As illustrated in the front view of FIG. 8B, the belt contact rotator 44 has a center hole 44a having a diameter D1 slightly larger than the outer diameter of the small diameter shaft 30a. The diameter D2 of the circular outer edge of the belt contact rotator 44 is longer than a combined length of the outer diameter of the roller portion of the tension roller 5 plus the thickness of the intermediate transfer belt 3. The belt detector 30 supports the belt contact rotator 44 so that the small diameter shaft 30a of the belt detector 30 is inserted into the center hole 44a. That is, the belt detector 30 supports the belt contact rotator 44 so that an upper region of the circumference of the center hole 44a of the belt contact rotator 44 contacts an upper region of the small diameter shaft 30a of the belt detector 30 in the direction of gravity. Further, the belt contact rotator 44 contacts the end face 30d of the belt detector 30 but is not secured to the end face 30d. As illustrated in FIG. 4, the belt contact rotator 44 is sandwiched between the edge of the intermediate transfer belt 3 and the end face 30d of the belt detector 30.

Without the belt contact rotator 44, the speed difference between the intermediate transfer belt 3 and the belt detector 30 is 0.7 by ratio (i.e., linear speed of the belt detector 30/linear speed of the intermediate transfer belt 3). On the other hand, when the belt contact rotator 44 is disposed between the intermediate transfer belt 3 and the belt detector 30, the speed difference between the intermediate transfer belt 3 and the belt contact rotator 44 is improved to about 0.9 by ratio (i.e., linear speed of the belt contact rotator 44/linear speed of the intermediate transfer belt 3). Although the speed difference varies depending on force of belt crawl, surface roughness of the edge of the intermediate transfer belt 3, and cut step of the intermediate transfer belt 3, the speed difference can be improved in any case in the present embodiment. The cut step is inevitably generated when the intermediate transfer belt 3 is cut to a predetermined width.

The belt contact rotator 44 disposed between the intermediate transfer belt 3 and the belt detector 30 reduces the speed difference between the intermediate transfer belt 3 and the belt contact rotator 44. As a result, damage to the intermediate transfer belt 3 and the belt contact rotator 44 is reduced. This reason is as follows.

According to the comparative configuration without the belt contact rotator 44, the belt detector 30 contacts the shaft inclination member 31 that does not rotate and the intermediate transfer belt 3, and thus is likely to receive the frictional resistance. Accordingly, the speed difference is likely to be generated between the intermediate transfer belt 3 and the belt detector 30. Therefore, the intermediate transfer belt 3 and the belt detector 30 are likely to receive damage.

On the other hand, in the configuration according to the present embodiment, the belt contact rotator 44 contacts the belt detector 30 that is rotatable and the intermediate transfer belt 3. Accordingly, the speed difference is less likely to be generated between the intermediate transfer belt 3 and the belt contact rotator 44. Therefore, the intermediate transfer belt 3 and the belt contact rotator 44 are less likely to receive damage. As a result, in the configuration according to the present embodiment, it is difficult to generate grinding dust between the intermediate transfer belt 3 and the belt contact rotator 44.

In the present embodiment, the belt contact rotator 44 has an annular shape as illustrated in FIG. 8B. However, when the belt contact rotator 44 is formed of a thin plate by punching, a burr is generated in a first face of the belt contact rotator 44 (hereinafter, referred to as “burr face”) at the time of punching. Therefore, a second face of the belt contact rotator 44 preferably contacts the intermediate transfer belt 3 so that the burr of the belt contact rotator 44 does not cause damage to the intermediate transfer belt 3. In other words, the burr face (first face), which is rougher than the second face, does not contact the intermediate transfer belt 3. That is, the belt contact rotator 44 is installed so that the first face (i.e., burr face) of the belt contact rotator 44 opposite to the second face, which contacts the intermediate transfer belt 3, has a surface roughness greater than that of the second face. To distinguish which is the burr face, the belt contact rotator 44 has, for example, an asymmetrical shape between the first face and the second face as illustrated in FIGS. 9A and 9C. This asymmetrical shape helps an assembler easily distinguish the first face and the second face and facilitate assembly of the belt contact rotator 44 with the burr face (first face) on the side opposite to the contact side on which the intermediate transfer belt 3 contacts the belt contact rotator 44 (the belt contact rotator 44 is installed with the second face without a burr adjacent to the intermediate transfer belt 3).

FIG. 9A is a front view illustrating a front face 44b of the belt contact rotator 44, which is the second face described above, FIG. 9B is a right side view of the belt contact rotator 44, and FIG. 9C is a rear view illustrating a back face 44h of the belt contact rotator 44, which is the first face described above. FIG. 9B schematically depicts burrs 44k formed by punching. Before attaching the belt detector 30 to the rotary shaft 5a of the tension roller 5, an assembler fits the center hole 44a of the belt contact rotator 44 to the small diameter shaft 30a of the belt detector 30 and attaches the belt contact rotator 44 to the end face 30d of the belt detector 30 while recognizing the shape of the front face 44b illustrated in FIG. 9A.

As a specific example, in the present embodiment, the belt contact rotator 44 is a substantially annular thin disc having an outer diameter D2 of 22.6 mm, an inner diameter D1 of 19.8 mm, and a thickness t of 0.2 mm. Two bow-shaped portions enclosed by a straight cut line (string) 44c and an arc 44e, and a straight cut line (string) 44d and an arc 44f are cut off from an annular disc as illustrated in FIG. 9A. The cut lines 44c and 44d have different lengths of 5 mm and 7.5 mm, respectively, and the two bow-shaped portion have different shapes. As a result, unlike the case in which the lengths of the cut lines 44c and 44d are the same, the front face 44b and the back face 44h are asymmetrical. In the case in which the lengths of the cut lines 44c and 44d are the same, for example, if the back face 44h illustrated in FIG. 9C of the belt contact rotator 44 is rotated counterclockwise by 90 degrees around the center of the center hole 44a, the shape of the belt contact rotator 44 is completely the same as the front face 44b illustrated in FIG. 9A.

When an assembler fits the center hole 44a to the small diameter shaft 30a of the belt detector 30 and attaches the belt contact rotator 44 to the end face 30d of the belt detector 30, the assembler holds the belt contact rotator 44 in posture in which the shorter cut line 44c of the two cut lines 44c and 44d having different lengths is horizontal at the top, and the portion 44g remaining in an arc shape between the two cut lines 44c and 44d is in the upper left as illustrated in FIG. 9A. This posture is possible only in the front face 44b. This shape of the front face 44b can be used as a guideline when the assembler attaches the belt contact rotator 44. Further, the length of contact with the edge of the intermediate transfer belt 3 can be reduced by the two bow-shaped portions cut off from the annular disc. Further, the cut lines (strings) 44c and 44d contact the edge of the intermediate transfer belt 3, thereby generating a frictional resistance. As a result, the speed difference between the intermediate transfer belt 3 and the belt contact rotator 44 can be further reduced.

The asymmetrical shape is not limited to the above-described shape. As described above, the outer diameter of the belt contact rotator 44 is longer than the combined length of the outer diameter of the tension roller 5 plus the thickness of the intermediate transfer belt 3. However, if the outer diameter is too large, the intermediate transfer belt may be damaged too much. Therefore, the outer diameter of the belt contact rotator 44 is preferably up to the combined length of the outer diameter of the tension roller 5 plus the thickness of the intermediate transfer belt 3 plus about 3 mm. In the present embodiment, the belt contact rotator 44 is made of, for example, polyethylene terephthalate (PET).

Since the belt detector 30 does not contact the intermediate transfer belt 3 that is a sharp thin film belt, the amount of wear of the belt detector 30 is small. However, since the belt contact rotator 44 contacts the intermediate transfer belt 3, the amount of wear of the belt contact rotator 44 may increase. Therefore, the belt detector 30 can be made of an inexpensive resin, but the belt contact rotator 44 preferably has a hardness (e.g., Rockwell hardness is 125 in R-scale) higher than that of the belt detector 30. The hardness of the belt contact rotator 44 is preferably not higher than that of the intermediate transfer belt 3 to minimize damage to the intermediate transfer belt 3.

If the hardness of the belt contact rotator 44 is too high, the intermediate transfer belt 3 may be damaged and broken. Further, the belt detector 30 is not required to be harder than necessary, and preferably has a hardness lower than that of the belt contact rotator 44. This is because if the hardness of the belt detector 30 is increased, the shaft inclination member 31 is ground or the cost is increased. Specifically, in the present embodiment, the belt detector 30 is made of POM (e.g., Rockwell hardness is 119 in R-scale), and the belt contact rotator 44 is harder than the belt detector 30.

An example of the configurations of the tension roller 5 and the intermediate transfer belt 3 according to the present disclosure is described as follows:

Tension roller 5
Outer diameter: 20 mm
Material: aluminum

Intermediate transfer belt 3
Material: polyimide
Young's modulus: 3400 MPa
Folding endurance measured by the Massachusetts Institute of Technology (MIT) folding endurance tester: 500 times
Thickness: 60 μm
Linear speed: 256 mm/s
Belt tension: 1.3 N/cm

The Folding endurance is measured by the Massachusetts Institute of Technology (MIT) folding endurance tester according to Japanese Industrial Standards (JIS)-P8115. More specifically, a sample belt having a width of 15 mm was measured under conditions of a testing load of 1 kgf, a flexion angle of 135 degrees, and a flexion speed of 175 times per minute.

As described above, according to the present embodiment, a belt contact rotator is disposed between a belt detector of a belt regulator and a belt, thereby reducing the speed difference between the belt and the belt contact rotator. As a result, damage to the belt and the belt contact rotator is reduced, thereby preventing grinding dust from being generated between the belt and the belt contact rotator. Therefore, a low-cost, durable belt device can be achieved that prevents grinding dust from being generated between the belt and the belt contact rotator and from adhering to the surrounding structure, and corrects belt crawl.

The present disclosure can prevent grinding dust from being generated and from adhering to a circumferential surface of a belt.

The above-described embodiment concerns the control for correcting belt crawl of the intermediate transfer belt, but the belt regulator can attain similar effects for correcting belt crawl of any belt other than the intermediate transfer belt, for example, a secondary transfer belt, a sheet conveyance belt for secondary transfer, a sheet conveyance belt for direct transfer method, a photoconductor belt, and the like.

The above-described embodiments are illustrative and do not limit the present disclosure. Thus, numerous additional modifications and variations are possible in light of the above teachings. For example, elements and/or features of different illustrative embodiments may be combined with each other and/or substituted for each other within the scope of the present disclosure.

What is claimed is:

1. A belt device comprising:
an endless belt;
a plurality of support rollers mounted on rotary shafts and configured to stretch and support the endless belt; and
a shaft displacement unit configured to displace the rotary shaft of one of the plurality of support rollers, the shaft displacement unit including:
a belt contact rotator rotatable and configured to contact an edge of the endless belt and move in a longitudinal axial direction of the one of the plurality of support rollers when the endless belt moves in the longitudinal axial direction;
a belt detector rotatable on the rotary shaft and movable relative to the rotary shaft when the belt contact rotator pushes the belt detector; and
a shaft inclination member not rotatable on the rotary shaft and movable relative to the rotary shaft when the belt detector pushes the shaft inclination member, the shaft inclination member having an inclined face with respect to the endless belt.

2. The belt device according to claim 1,
wherein the belt contact rotator has a first face with a burr and a second face different from the first face and without a burr, and
wherein the second face without the burr is adjacent to the endless belt to contact the endless belt.

3. The belt device according to claim 2,
wherein the first face and the second face of the belt contact rotator are asymmetric.

4. The belt device according to claim 1,
wherein the belt contact rotator has a hardness greater than a hardness of the belt detector.

5. A transfer device comprising the belt device according to claim 1.

6. An image forming apparatus comprising the transfer device according to claim 5.

7. An image forming apparatus comprising the belt device according to claim 1.
